(19) United States
(12) Patent Application Publication
(10) Pub. No.: US 2008/0130516 A1
(43) Pub. Date: Jun. 5, 2008

(54) P2p Overplay Network Construction Method and Apparatus

(75) Inventors: Tae-Wan You, Daejeon-city (KR); Seung Yun Lee, Daejeon-city (KR); Ho-Sik Cho, Seoul (KR); Min-Ji Nam, Seoul (KR); Kun-Woo Park, Seoul (KR); Tae-Kyoung Kwon, Seoul (KR); Yang-Hee Choi, Seoul (KR)

Correspondence Address: LAHIVE & COCKFIELD, LLP, ONE POST OFFICE SQUARE, BOSTON, MA, 02109-2127, US

(73) Assignee: Electronics and Telecommunications Research Institute, Daejeon (KR)

(21) Appl. No.: 11/793,791

(22) PCT Filed: Oct. 21, 2005
(86) PCT No.: PCT/KR05/03523

§ 371 Date: Jun. 21, 2007

(30) Foreign Application Priority Data
Dec. 21, 2004 (KR) 10-2004-0109698
May 11, 2005 (KR) 10-2004-0039228

(51) Int. Cl. H04L 12/28

(52) U.S. Cl. 370/254

(57) ABSTRACT

Provided are a method and apparatus for constructing a peer-to-peer (P2P) overlay network. The method of constructing a peer-to-peer (P2P) overlay network to obtain ID values of a plurality of nodes using a distributed hash table (DHT) and registering a node wishing to join the P2P overlay network where the plurality of nodes are sequentially located based on the obtained ID values, includes: (a) transmitting a join request message from the node wishing to join the P2P overlay network to a key node of the P2P overlay network; (b) a first node that received the join request message determining whether an ID value of the node wishing to join the P2P overlay network is a between value of an ID value of the first node and an ID value of a second node next to the first node, while sequentially transmitting the join request message to the plurality of nodes; and (c), if the first node determines that the ID value of the node wishing to join the P2P overlay network is the between value, registering the node wishing to join the P2P overlay network between the first and second nodes. Therefore, it is possible to more easily and efficiently search for sharing resources stored by each of the nodes.

### TECHNICAL FIELD

The present invention relates to a method and apparatus for constructing a P2P overlay network, and more particularly, to a method and apparatus for constructing a P2P overlay network and easily and effectively searching for resource shared by nodes in a distributed environment such as Internet.

### BACKGROUND ART

Although a network is constructed to provide commercial services beyond the level of a trial network, Internet protocol version 6 (IPv6) is limited to applications. Therefore, a lot of applications used in a commercial network must be developed in order to facilitate an IPv6 network. In particular, since a peer-to-peer (P2P) application designed for end-to-end services that is a basic principle of Internet is regarded as a next-generation application, the development and supply of P2P applications will contribute greatly to earlier use of the IPv6 network.

A conventional algorithm, i.e., P2P, that is a protocol of an application level such as hyper text transfer protocol (HTTP) supports real time communications, resource distribution, resource exchange, etc. between computer users. P2P networks can be classified into hybrid P2P networks using a server, and pure P2P networks where every node serves as a server and a client. Pure P2P networks that are based on a fundamental concept of P2P cannot search for and find resource shared by nodes in a large-scale network.

A hybrid P2P network shares resources with each of a plurality of nodes through the server, and comprises a central server providing services and P2P nodes having substantial sharing resources. The central server maintains a network connection session from each of the node, manages meta data of sharing resources, and easily searches for resources required by the P2P nodes. Each of the P2P nodes accesses the server to search for a node that holds resources in order to search for the sharing resources. A resource is actually exchanged between two connected nodes. Napster was one of the first widely used hybrid P2P networks. However, a hybrid P2P network has limited extensibility, and increases costs, and is not stable due to centralization.

Examples of widely used pure P2P networks are Gnutella and Freenet. Gnutella forms a network by connecting each of a plurality of nodes in terms of applications. Each of the nodes floods a search message into a predetermined range to search for a file and obtains information of a node that holds the file. However, since each of the nodes floods a search message periodically into the Gnutella network, the pure P2P network has limited extensibility.

Meanwhile, a P2P overlay network that is constructed by the combination of an actual value and a key obtained from a hash function using a hash table provides extensibility and stability. Chord, Pastry, and CAN are protocols for P2P overlay networks based on a distributed hash table (DHT).

Chord uses an m-bit virtual identification space to assign nodes and sharing files in identification values obtained from a hash function. Also, each of the nodes maintains a routing table called a finger table to easily search for resources.

Pastry proposed by Microsoft assigns uniformly distributed node identifications randomly from a circular 128-bit identification space through an encoding hash. Given a 128-bit key, Pastry routes an associated message toward a live node whose node identification is numerically closest to the key. Each node keeps track of its neighbor set and notifies applications of changes in the set.

CAN obtains a vector P (p=hash(key)) corresponding to a point in a d-dimensional space through the hash function. Each of the nodes stores data corresponding to a zone divided from a virtual space.

The hybrid P2P network has disadvantages in terms of cost, extensibility, and stability due to the central server. The P2P overlay network that is a type of pure P2P network has disadvantage in terms of extensibility caused by an increase of traffic due to frequent flooding of messages.

Although Chord, Pastry, and CAN protocols provide extensibility, stability, and convenience, their suggested methods are too complex to be realized. Also, they do not search for a file due to the disadvantage of the DHT rather than the file is searched use a keyword. Also, they are suitable for a specific P2P application such as storage in the distributed environment.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a resource locator based on an ID value obtained from a node and a sharing file using a hash file according to an embodiment of the present invention;

FIG. 2 illustrates a method of joining a P2P overlay network using a node wishing to join the P2P overlay network according to an embodiment of the present invention;

FIG. 3 illustrates a method of acknowledging whether neighboring nodes located within 2 hops of a key node and a friend node operate according to an embodiment of the present invention;

FIG. 4 illustrates a method of registering resource information locators of sharing files of a node to the P2P overlay network according to an embodiment of the present invention;

FIG. 5 illustrates a method of searching for a sharing file stored by other node using a node according to an embodiment of the present invention;

FIG. 6 illustrates a method of searching for a sharing file stored by other node using a node according to another embodiment of the present invention;

FIG. 7 illustrates a method of solving a redundant ID value when a node having the redundant ID value joins the P2P overlay network using a different Internet protocol (IP) address according to an embodiment of the present invention; and

FIG. 8 illustrates a neighboring node table and a friend node table stored by a 19^{th} node illustrated in FIG. 3

### DETAILED DESCRIPTION OF THE INVENTION

### Technical Goal of the Invention

Conventionally, although Chord, Pastry, and CAN protocols provide extensibility, stability, and convenience, their suggested methods are too complex to be realized. Also, they do not search for files a distributed hash table (DHT). Instead, the files are searched using keywords. Also, they are suitable for a specific P2P application such as storage in the distributed environment.

### DISCLOSURE OF THE INVENTION

According to an aspect of the present invention, there is provided a method and apparatus for constructing a peer-to-peer (P2P) overlay network through message routing by assigning nodes and sharing resources suitably in a distributed environment using a distributed hash table (DHT), and storing location information on neighboring nodes and friend nodes.

According to another aspect of the present invention, there is provided a method of searching for files by maintaining P2P characteristics, and constructing a P2P overlay network using a friend node synchronized with an instant messenger.

### EFFECT OF THE INVENTION

The present invention relating to a method and apparatus for constructing a P2P overlay network makes it possible for every node to serve as a server and a client using a pure P2P application/protocol having basic P2P characteristics, and provides extensibility, reliability, maintenance & repair, and user convenience using a DHT to construct the P2P overlay network suitable for a distributed environment such as the Internet.

The present invention maintains a routing table called a resource locator to more effectively search for resources, and exchanges simple-constituted messages to construct and maintain and repair the P2P overlay network.

The P2P overlay network is based on a next-generation Internet IPv6 protocol, provides application services mostly used in the Internet such as instant messenger applications, voice on demand (VoD) services, resource sharing, etc., provides many users with a variety of services based on IPv6 protocol, and contributes to earlier use of the IPv6 protocol.

### BEST MODE FOR CARRYING OUT THE INVENTION

According to an aspect of the present invention, there is provided a method of constructing a peer-to-peer (P2P) overlay network to obtain ID values of a plurality of nodes using a distributed hash table (DHT) and registering a node wishing to join the P2P overlay network where the plurality of nodes are sequentially located based on the obtained ID values, the method comprising: (a) transmitting a join request message from the node wishing to join the P2P overlay network to a key node of the P2P overlay network; (b) a first node that receives the join request message determining whether an ID value of the node wishing to join the P2P overlay network is a between value of an ID value of the first node and an ID value of a second node next to the first node, while sequentially transmitting the join request message to the plurality of nodes; and (c), if the first node determines that the ID value of the node wishing to join the P2P overlay network is the between value, registering the node wishing to join the P2P overlay network between the first and second nodes.

According to another aspect of the present invention, there is provided a method of constructing a P2P overlay network to obtain ID values of a plurality of nodes using a DHT and registering a node wishing to join the P2P overlay network where the plurality of nodes are sequentially located based on the obtained ID values, the method comprising: (a) transmitting a join request message from the node wishing to join the P2P overlay network to a key node of the P2P overlay network; (b) a first node that receives the join request message determining whether an ID value of the node wishing to join the P2P overlay network is identical to an ID value of the first node, while sequentially transmitting the join request message to the plurality of nodes; and (c), if the first node determines that the ID value of the node wishing to join the P2P overlay network is identical to the ID value of the first node, the first node transmitting a password request message to the node wishing to join the P2P overlay network; (d) the first node receiving a password from the node wishing to join the P2P overlay network; and (e) if the password received by the first node is identical to a password used to register the first node, replacing the first node with the node wishing to join the P2P overlay network.

According to still another aspect of the present invention, there is provided a method of registering a resource information locator of a sharing file using a node that obtains ID values of a plurality of nodes using a DHT and stores the sharing file in a P2P overlay network where the plurality of nodes are sequentially located based on the obtained ID values, the method comprising: calculating a file ID value by hashing the sharing file using the DHT; (b) while sequentially transmitting a file register message comprising the file ID value to the plurality of nodes, a first node that received the file register message determining whether the file ID value is a between value of an ID value of the first node and an ID value of a second node next to the first node; and (c), if the first node determines that the file ID value is the between value, the first node registering the resource information locator of the sharing file.

According to yet another aspect of the present invention, there is provided a method of searching for a sharing file using a node that obtains ID values of a plurality of nodes using a DHT and wishes to search for the sharing file in a P2P overlay network where the plurality of nodes are sequentially located based on the obtained ID values, the method comprising: calculating a file ID value by hashing a name of the sharing file using the DHT; (b) while sequentially transmitting a file search message comprising the file ID value to the plurality of nodes, a first node that receives the file search message determining whether the file ID value is a between value of an ID value of the first node and an ID value of a second node next to the first node; (c), if the first node determines that the file ID value is the between value, the first node registering a search acknowledge message comprising a resource information locator of the sharing file to the node wishing to search for the sharing file; and (d) the node wishing to search for the sharing file connected to a node having the sharing file through the resource information locator and searching for the sharing file.

According to further aspect of the present invention, there is provided a method of searching for a sharing file using a node that obtains ID values of a plurality of nodes using a DHT and wishes to search for the sharing file in a P2P overlay network where the plurality of nodes are sequentially located based on the obtained ID values, the method comprising: calculating a file ID value by hashing a name of the sharing file using the DHT; (b) while sequentially transmitting a file search message comprising the file ID value to the plurality of nodes, a first node that receives the file search message determining whether the file ID value is included in a sharing file list already stored in the first node; (c), if the first node determines that the file ID value is included in the sharing file list already stored in the first node, the first node transmitting the file search message to a node that has already transmitted the sharing file list identical to the file ID value; (d) the node that has already transmitted the sharing file list transmitting a search acknowledge message comprising a resource information locator of the file ID value to the node wishing to search for the sharing file; and (e) the node wishing to search for the sharing file connected to a node having the sharing file through the resource information locator and searching for the sharing file.

According to further aspect of the present invention, there is provided an apparatus for obtaining ID values of a plurality of nodes using a DHT and constructing a P2P overlay network where the plurality of nodes are sequentially located based on the obtained ID values, wherein the plurality of nodes comprises a neighboring node table that stores resource information locators of nodes neighboring each of the nodes within 2 hops in both directions of each of the nodes; and a friend node table that stores resource information locators of friend nodes synchronized with an instant messenger.

### EMBODIMENTS

The present invention will now be described more fully with reference to the accompanying drawings.

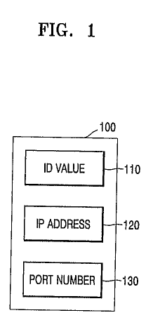

FIG. 1 is a block diagram of a resource locator 100 based on an ID value obtained from a node and a sharing file using a hash file according to an embodiment of the present invention. Referring to FIG. 1, the resource locator 100 comprises an ID value 110, an Internet protocol (IP) address 120, and a port number 130.

The ID value 110 is obtained by hashing the node or the sharing file using a distributed hash table (DHT). In this regard, the node obtains the ID value 110 by hashing an e-mail address using a message digest 5 (MD5) hash function. The sharing file obtains the ID value 110 by hashing a file name using the MD5 hash function. The obtained ID value 110 is located in a counterclockwise direction in a circular virtual space.

The resource locator 100 comprises the ID value 110 of the node and the sharing file in the counterclockwise direction, the IP address 120 of the node, and the port number 130 providing an application service. The IP address 120 is Internet protocol version 6 (IPv6) of an actual node.

Although the obtained ID value 110 of the current embodiment is located in a counterclockwise direction in a circular virtual space, it may be located in a clockwise direction in the circular virtual space in another embodiment.

Also, the present invention relates to a new P2P overlay network operated using IPv6, unlike a conventional P2P overlay protocol.

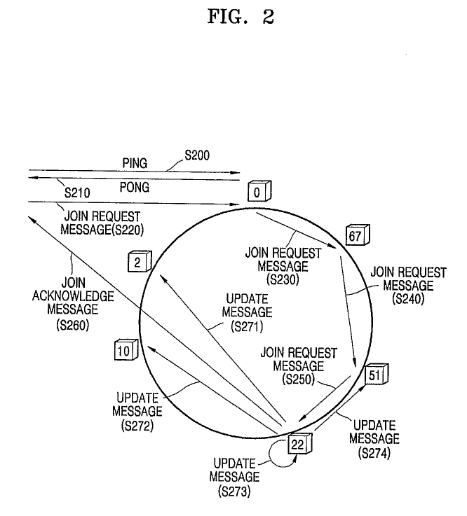

FIG. 2 illustrates a method of joining a P2P overlay network using a node wishing to join the P2P overlay network according to an embodiment of the present invention. In detail, FIG. 2 shows operations on how a 17^{th} node having an ID value 17 (i.e. the node wishing to join) joins the P2P overlay network.

Referring to FIG. 2, the 17^{th} node transmits a PING message to determine whether a 0^{th} node, i.e., a key node, is operating to the 0^{th} node using information on the 0^{th} node (Operation 200) when a P2P application starts. The key node is regarded as a special node that can be connected all the time and whose address is known to all nodes at first. The information on the key node is loaded when the P2P application starts to obtain information on neighboring nodes or a particular IP address through a domain name system (DNS). The 0^{th} node having an ID value 0 is set as the key node in the P2P overlay network illustrated in FIG. 2.

If it is determined that the 0^{th} node that receives the PING message is operating, the 0^{th} node transmits a PONG message to the 17^{th} node (Operation 210).

The 17^{th} node transmits a join request message JOIN to the 0^{th} node (Operation 220). As described above, every node transmits a join request message to the 0^{th} node (the key node) to join the P2P overlay network for the first time.

The 0^{th} node transmits the join request message in a clockwise direction to form a virtual circular space where the 17^{th} node is located (Operations 230, 240, and 250). Since the 17^{th} node is located at the left of a 22^{nd} node in FIG. 2, the 0^{th} node transmits the join request message to the 22^{nd} node.

The 22^{nd} node which receives the join request message transmits a join acknowledgement message JACK to the 17^{th} node indicating that the 22^{nd} node is successfully located in the P2P overlay network (Operation 260).

Since a node must have information on neighboring nodes within 2 hops, the 22^{nd} node transmits an update message including resource information locators of the 17^{th} node to a 2^{nd} node, a 10^{th} node, the 22^{nd} node, and a 51^{st} node that are neighboring nodes of the 17^{th} node (Operations 271, 272, 273, and 274), and receives the resource information locators from the 2^{nd} node, the 10^{th} node, the 22^{nd} node, and the 51^{st} node, and registers them. Referring to FIG. 2, resource information locators are transmitted to the 2^{nd} node (Operation 271), the 10^{th} node (Operation 272), the 22^{nd} node (Operation 273), and the 51^{st} node (Operation 274).

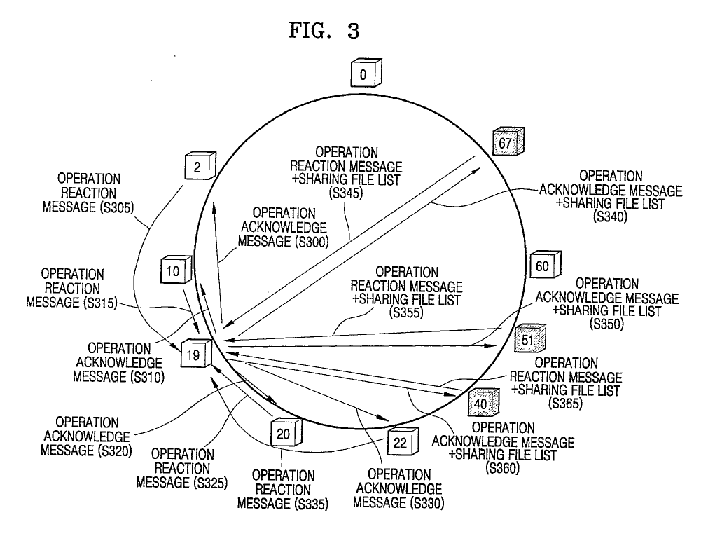

The node that successfully joins the P2P overlay network obtains information on neighboring nodes, and directly receives a sharing file list from a friend node such as an instant messenger. Also, the node periodically transmits an operation acknowledge message HELLO to maintain and repair the P2P overlay network. This will be described with reference to FIG. 3.

FIG. 3 illustrates a method of acknowledging whether neighboring nodes located within 2 hops of a key node and a friend node operate according to an embodiment of the present invention. A message is transmitted in a clockwise direction from a key node (0^{th} node) in the P2P overlay network, and an ID value of a node or a file becomes smaller in the clockwise direction from the key node.

Referring to FIG. 3, a 19^{th} node (having the ID value 19) successfully joins the P2P overlay network, transmits an operation acknowledge message HELLO to neighboring nodes of the 19^{th} node and the friend node to check round trip time (RTT), and acknowledges whether the neighboring nodes operate well.

The 19^{th} node transmits the operation acknowledge message to a 2^{nd} node two nodes to the left of the 19^{th} node (Operation 300). The 19^{th} node receives an operation reaction message HACK indicating that the 2^{nd} node is operating from the 2^{nd} node that receives the operation acknowledge message (Operation 305), thereby acknowledging that the 2^{nd} node is operating. Meanwhile, when the 2^{nd} node is not operating in Operation 305, the 19^{th} node does not receive the operation reaction message, thereby acknowledging that the 2^{nd} node is not operating.

The 19^{th} node transmits the operation acknowledge message to a 10^{th} node at the left of the 19^{th} node (Operation 310). The 19^{th} node receives the operation reaction message HACK indicating that the 10^{th} node is operating from the 10^{th} node that receives the operation acknowledge message (Operation 315), thereby acknowledging that the 10^{th} node is operating. Meanwhile, when the 10^{th} node is not operating in Operation 315, the 19^{th} node does not receive the operation reaction message, thereby acknowledging that the 10^{th} node is not operating.

The 19^{th} node transmits the operation acknowledge message to a 20^{th} node at the right of the 19^{th} node (Operation 320). The 19^{th} node receives the operation reaction message HACK indicating that the 20^{th} node is operating from the 20^{th} node that receives the operation acknowledge message (Operation 325), thereby acknowledging that the 20^{th} node is operating. Meanwhile, when the 20^{th} node is not operating in Operation 325, the 19^{th} node does not receive the operation reaction message, thereby acknowledging that the 20^{th} node is not operating.

The 19^{th} node transmits the operation acknowledge message to a 22^{nd} node two nodes to the right of the 19^{th} node (Operation 330). The 19^{th} node receives the operation reaction message HACK indicating that the 22^{nd} node is operating from the 22^{nd} node that receives the operation acknowledge message (Operation 335), thereby acknowledging that the 22^{nd} node is operating. Meanwhile, when the 22^{nd} node is not operating in Operation 335, the 19^{th} node does not receive the operation reaction message, thereby acknowledging that the 22^{nd} node is not operating.

The 19^{th} node transmits a list of files shared by the 19^{th} node and the operation acknowledge message to a 67^{th} node, a 51^{st} node, and a 40^{th} node that are friend nodes of the 19^{th} node (Operations 340, 350, and 360). The 19^{th} node receives operation reaction messages indicating that the 67^{th} node, the 51^{st} node, and the 40^{th} node are operating from the 67^{th} node, the 51^{st} node, and the 40^{th} node that received the operation acknowledge message, and lists of files shared by the 67^{th} node, the 51^{st} node, and the 40^{th} node (Operations 345, 355, and 365), thereby acknowledging from the operation reaction message that the 67^{th} node, the 51^{st} node, and the 40^{th} node are operating. Also, the 19^{th} node receives the sharing file lists from each of the 67^{th} node, the 51^{st} node, and the 40^{th} node, and stores them.

If the 67^{th} node, the 51^{st} node, and the 40^{th} node are not operating in Operations 345, 355, and 365, the 19^{th} node does not receive the operation reaction message, thereby acknowledging that the 67^{th} node, the 51^{st} node, and the 40^{th} node are not operating.

The above operations illustrated in FIG. 3 may be performed simultaneously or according to other rules.

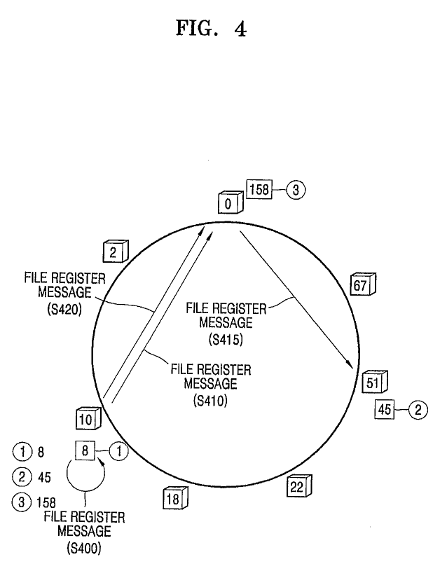

FIG. 4 illustrates a method of registering resource information locators of sharing files of a node to a P2P overlay network according to an embodiment of the present invention. A message is transmitted in a clockwise direction from a key node (0^{th} node) in the P2P overlay network, and an ID value of a node or a file becomes smaller in the clockwise direction from the key node.

Referring to FIG. 4, a 10^{th} node (having the ID value 10) registers each of the resource information locators based on ID values of sharing files stored by the 10^{th} node to the P2P overlay network. The 10^{th} node uses information on neighboring nodes to determine the ID values of sharing files as the ID value of the node, thereby locating the resource information locators in the node of the circular space, i.e., the P2P overlay network.

The 10^{th} node acknowledges information on its neighboring nodes, and stores a resource information locator of an 8^{th} file (having the ID value 8) in the 10^{th} node since the 8^{th} file is located at a 10^{th} node and a 2^{nd} node (Operation 400).

The 10^{th} node acknowledges the information on its neighboring nodes, and transmits a resource information locator of a 45^{th} file (having the ID value 45) to a 0^{th} node (Operation 410). The 0^{th} node acknowledges information on its neighboring nodes, and transmits the resource information locator of the 45^{th} file to a 51^{st} node (Operation 415). The 51^{st} node decides the 45^{th} file to store in the 51^{st} node according to the information on its neighboring nodes and stores the resource information locator of the 45^{th} file. In detail, since the 45^{th} file is located between the 51^{st} node and a 22^{nd} node, the 51^{st} node stores the resource information locator of the 45^{th} file in the 51^{st} node.

An 8^{th} node acknowledges information on its neighboring nodes, and transmits a resource information locator of a 158^{th} file to the 0^{th} node (Operation 420). The 0^{th} node decides the 158^{th} file to store in the 0^{th} node according to the information on its neighboring nodes and stores the resource information locator of the 158^{th} file. In detail, since the 158^{th} file is located between the 0^{th} node and a 67^{th} node, the 0^{th} node stores the resource information locator of the 158^{th} file in the 0^{th} node.

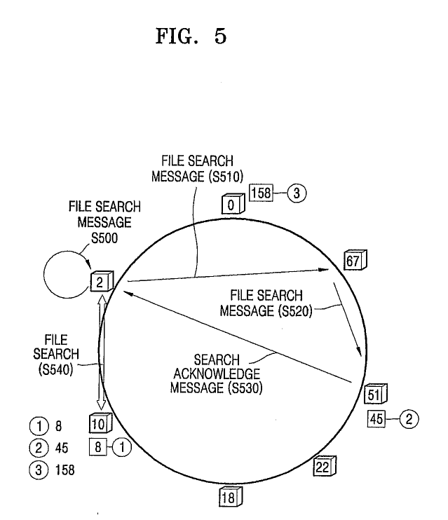

FIG. 5 illustrates a method of searching for a sharing file stored by other nodes using a node according to an embodiment of the present invention. A message is transmitted in a clockwise direction from a key node (0^{th} node) in a P2P overlay network, and an ID value of a node or a file becomes smaller in the clockwise direction from the key node.

Referring to FIG. 5, a 2^{nd} node (having an ID value 2) receives a file search message to search for a 45^{th} file (having the ID value 45) (Operation 500).

The 2^{nd} node sequentially transmits the file search message to nodes that seemingly store a resource information locator of the 45^{th} file according to ID values of neighboring nodes of the 2^{nd} node. More specifically, since the 2^{nd} node stores resource information locators of a 0^{th} node and a 67^{th} node that are neighboring nodes within 2 hops of the 2^{nd} node in a direction of transmitting the file search message in the P2P overlay network, the 2^{nd} node transmits the file search message to search for the resource information locator of the 45^{th} file to the 67^{th} node that is closer to the 45^{th} file in the 0^{th} node and the 67^{th} node (Operation 510).

Since the 67^{th} node which receives the file search message stores resource information locators of a 51^{st} node and a 22^{nd} node that are neighboring nodes of the 67^{th} node in the direction of transmitting the file search message in the P2P overlay network, the 67^{th} node transmits the file search message to the 51^{st} node (Operation 520) in view of the fact that the 51^{st} node stores the resource information locator of the 45^{th} file in the 51^{st} node and the 22^{nd} node.

The 51^{st} node which receives the file search message transmits a search acknowledge message including the resource information locator of the 45^{th} file to the 2^{nd} node (Operation 530).

The 2^{nd} node connects to a 10^{th} node using the resource information locator that actually stores the 45^{th} file and searches for the 45^{th} file (Operation 540).

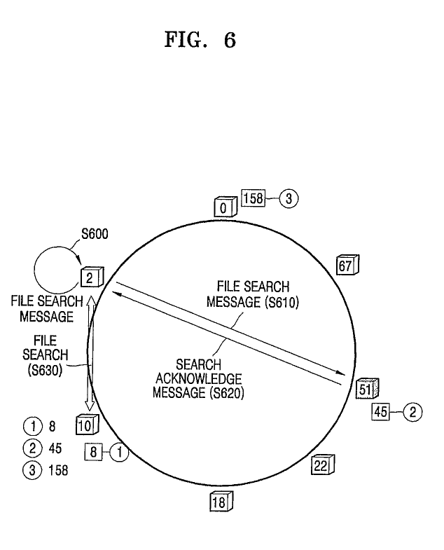

FIG. 6 illustrates a method of searching for a sharing file stored by other nodes using a node according to another embodiment of the present invention. A message is transmitted in a clockwise direction from a key node (0^{th} node) in the P2P overlay network, and an ID value of a node or a file becomes smaller in the clockwise direction from the key node.

Referring to FIG. 6, a 2^{nd} node (having an ID value 2) receives a file search message to search for a 45^{th} file (having the ID value 45) (Operation 600).

The 2^{nd} node determines whether a node stores a resource information locator of the 45^{th} file according to a file list of friend nodes of the 2^{nd} node, and transmits the file search message to a friend node having the file list (Operation 610). More specifically, since the 2^{nd} node has the file information list of the friend nodes of the 2^{nd} node in the P2P overlay network, the 2^{nd} node transmits the file search message to a 51^{st} node in view of the fact that the 51^{st} node which is a friend node stores the resource information locator of the 45^{th} file from the file list of the 45^{th} file.

The 51^{st} node that received the file search message transmits a search acknowledge message including the resource information locator of the 45^{th} file to the 2^{nd} node (Operation 620).

The 2^{nd} node connects to a 10^{th} node using the resource information locator that actually stores the 45^{th} file and searches for the 45^{th} file (Operation 630).

Therefore, it is more efficient to simplify an operation of searching for a file using a friend node. More specifically, the friend node is used as a shortcut in a ring forming the P2P overlay network, thereby efficiently searching for a file.

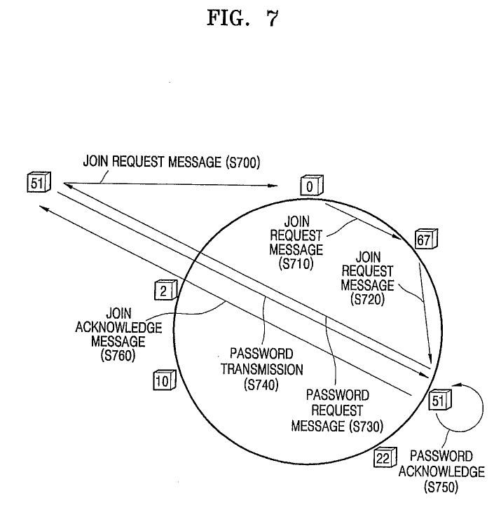

FIG. 7 illustrates a method of solving a redundant ID value when a node having the redundant ID value joins a P2P overlay network using a different Internet protocol (IP) address according to an embodiment of the present invention. In the current embodiment of the present invention, an ID value of the node is obtained from an e-mail address. Therefore, a user joins the P2P overlay network at the different IP address using the same e-mail address, which causes a problem in joining the P2P overlay network due to the same ID value. To solve this problem, a method of solving the redundant ID value according to the current embodiment of the present invention is provided.

Referring to FIG. 7, although a 51^{st} node (having the ID value 51) is already located in the P2P overlay network, the 51^{st} node that wishes to join the P2P overlay network at the different IP address using the same ID value transmits a join request message JOIN to a 0^{th} node (a key node) (Operation 700). Every node transmits the join request message to the 0^{th} node (the key node) to join the P2P overlay network for the first time.

The 0^{th} node transmits the join request message to a 67^{th} node neighboring the 0^{th} node in a clockwise direction to form a virtual circular space where the 51^{st} node that wishes to join the P2P overlay network is located (Operation 710).

The 67^{th} node transmits the join request message to the already joined 51^{st} node neighboring the 67^{th} node in a clockwise direction to form the virtual circular space where the 51^{st} node that wishes to join the P2P overlay network is located (Operation 720).

The join request message is delivered to the already joined 51^{st} node. In view of the fact that the already joined 51^{st} node received the join request message from the same ID value, the already joined 51^{st} node requests a password of the 51^{st} node that wishes to join the P2P overlay network by transmitting a password request message (Operation 730).

The 51^{st} node that wishes to join the P2P overlay network encodes the password using a hash function, and transmits the encoded password to the already joined 51^{st} node (Operation 740).

The already joined 51^{st} node decodes the encoded password and determines whether the encoded and decoded passwords are identical to each other (Operation 750).

If the already joined 51^{st} node determines that the passwords are identical to each other at Operation 750, the already joined 57^{th} node allows the 51^{st} node that wishes to join the P2P overlay network to join the P2P overlay network, and transmits a join acknowledge message to the 51^{st} node that wishes to join the P2P overlay network (Operation 760). The newly joined 51^{st} node transmits an update message to its neighboring nodes to inform them of a node change.

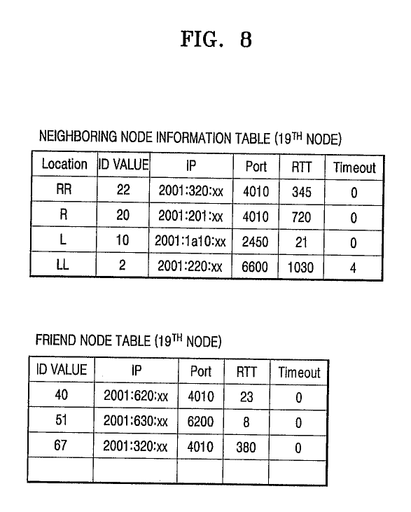

FIG. 8 illustrates a neighboring node table and a friend node table stored by the 19^{th} node illustrated in FIG. 3. Referring to FIG. 8, the neighboring node table includes resource information locators of neighboring nodes of the 19^{th} node, and a friend node table includes resource information locators of friend nodes of the 19^{th} node.

The neighboring node table stores the resource information locators at the right of the right RR, the right R, the left L, and the left of the left LL from each of the nodes. More specifically, referring to FIG. 3, the neighboring node table stores information on ID values, IP addresses, port numbers, RTT, and timeout of the 19^{th} node at the right of the right RR, the 20^{th} node at the right R, the 10^{th} node at the left L, and the 2^{nd} node at the left LL of the left.

The friend node table stores resource information locators of friend nodes according to an instant messenger. More specifically, referring to FIG. 3, the friend node table of the 19^{th} node stores information on ID values, IP addresses, port numbers, RTT, and timeout of friend nodes, i.e., the 40^{th} node, the 51^{st} node, and the 67^{th} node.

It is possible for the present invention to be realized on a computer-readable recording medium as a computer-readable code. Computer-readable recording mediums include every kind of recording device that stores computer system-readable data. ROMs, RAMs, CD-ROMs, magnetic tapes, floppy discs, optical data storage, etc. are used as a computer-readable recording medium. Computer-readable recording mediums can also be realized in the form of a carrier wave (e.g., transmission through Internet). A computer-readable recording medium is dispersed in a network-connecting computer system, resulting in being stored and executed as a computer-readable code by a dispersion method.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the present invention is defined not by the detailed description of the invention but by the appended claims, and all differences within the scope of the present invention will be construed as being included in the present invention.

1. A method of constructing a peer-to-peer (P2P) overlay network to obtain ID values of a plurality of nodes using a distributed hash table (DHT) and registering a node wishing to join the P2P overlay network where the plurality of nodes are sequentially located based on the obtained ID values, the method comprising:
(a) transmitting a join request message from the node wishing to join the P2P overlay network to a key node of the P2P overlay network;
(b) a first node that receives the join request message determining whether an ID value of the node wishing to join the P2P overlay network is a between value of an ID value of the first node and an ID value of a second node next to the first node, while sequentially transmitting the join request message to the plurality of nodes; and
(c), if the first node determines that the ID value of the node wishing to join the P2P overlay network is the between value, registering the node wishing to join the P2P overlay network between the first and second nodes.

2. The method of claim 1, further comprising: (d) the first node transmitting a join acknowledge message indicating the success of the registration to the node wishing to join the P2P overlay network.

3. The method of claim 2, wherein the plurality of nodes store resource information locators of nodes neighboring each of the nodes within 2 hops in both directions of each of the nodes.

4. The method of claim 3, further comprising: (f) the first node transmitting a resource information locator of the node wishing to join the P2P overlay network to nodes neighboring the node wishing to join the P2P overlay network within 2 hops in both directions of the node wishing to join the P2P overlay network.

5. A method of constructing a P2P overlay network to obtain ID values of a plurality of nodes using a DHT and registering a node wishing to join the P2P overlay network where the plurality of nodes are sequentially located based on the obtained ID values, the method comprising:
(a) transmitting a join request message from the node wishing to join the P2P overlay network to a key node of the P2P overlay network;
(b) a first node that receives the join request message determining whether an ID value of the node wishing to join the P2P overlay network is identical to an ID value of the first node, while sequentially transmitting the join request message to the plurality of nodes; and
(c), if the first node determines that the ID value of the node wishing to join the P2P overlay network is identical to the ID value of the first node, the first node transmitting a password request message to the node wishing to join the P2P overlay network;
(d) the first node receiving a password from the node wishing to join the P2P overlay network; and
(e) if the password received by the first node is identical to a password used to register the first node, replacing the first node with the node wishing to join the P2P overlay network.

6. The method of claim 5, wherein the plurality of nodes store resource information locators of nodes neighboring each of the nodes within 2 hops in both directions of each of the nodes.

7. The method of claim 6, further comprising: (f) the node wishing to join the P2P overlay network that was replaced with the first node and registered, transmitting a resource information locator of the node wishing to join the P2P overlay network to nodes neighboring the registered node within 2 hops in both directions of the registered node.

8. A method of registering a resource information locator of a sharing file using a node that obtains ID values of a plurality of nodes using a DHT and stores the sharing file in a P2P overlay network where the plurality of nodes are sequentially located based on the obtained ID values, the method comprising:
(a) calculating a file ID value by hashing the sharing file using the DHT;
(b) while sequentially transmitting a file register message comprising the file ID value to the plurality of nodes, a first node that received the file register message determining whether the file ID value is a between value of an ID value of the first node and an ID value of a second node next to the first node; and
(c), if the first node determines that the file ID value is the between value, the first node registering the resource information locator of the sharing file.

9. The method of claim 8, wherein the plurality of nodes store resource information locators of nodes neighboring each of the nodes within 2 hops in both directions of each of the nodes.

10. A method of searching for a sharing file using a node that obtains ID values of a plurality of nodes using a DHT and wishes to search for the sharing file in a P2P overlay network where the plurality of nodes are sequentially located based on the obtained ID values, the method comprising:
(a) calculating a file ID value by hashing a name of the sharing file using the DHT;
(b) while sequentially transmitting a file search message comprising the file ID value to the plurality of nodes, a first node that receives the file search message determining whether the file ID value is a between value of an ID value of the first node and an ID value of a second node next to the first node;
(c), if the first node determines that the file ID value is the between value, the first node registering a search acknowledge message comprising a resource information locator of the sharing file to the node wishing to search for the sharing file; and
(d) the node wishing to search for the sharing file connected to a node having the sharing file through the resource information locator and searching for the sharing file.

11. A method of searching for a sharing file using a node that obtains ID values of a plurality of nodes using a DHT and wishes to search for the sharing file in a P2P overlay network where the plurality of nodes are sequentially located based on the obtained ID values, the method comprising:
(b) calculating a file ID value by hashing a name of the sharing file using the DHT;
(b) while sequentially transmitting a file search message comprising the file ID value to the plurality of nodes, a first node that receives the file search message determining whether the file ID value is included in a sharing file list already stored in the first node;
(c), if the first node determines that the file ID value is included in the sharing file list already stored in the first node, the first node transmitting the file search message to a node that has already transmitted the sharing file list identical to the file ID value;
(d) the node that has already transmitted the sharing file list transmitting a search acknowledge message comprising a resource information locator of the file ID value to the node wishing to search for the sharing file; and
(e) the node wishing to search for the sharing file connected to a node having the sharing file through the resource information locator and searching for the sharing file.

12. The method of claim 10, wherein, if the first node determines that the file ID value is not included in the sharing file list already stored in the first node, while a file search message comprising the file ID value to the plurality of nodes is sequentially transmitted, a node that received the file search message determines whether the file ID value is a between value of an ID value of the node that received the file search message and an ID value of a node next to the node that received the file search message, and, when it is determined that the file ID value is the between value, the file search message is transmitted to the node that received the file search message.

13. An apparatus for obtaining ID values of a plurality of nodes using a DHT and constructing a P2P overlay network where the plurality of nodes are sequentially located based on the obtained ID values, wherein the plurality of nodes comprises a neighboring node table that stores resource information locators of nodes neighboring each of the nodes within 2 hops in both directions of each of the nodes; and a friend node table that stores resource information locators of friend nodes synchronized with an instant messenger.

14. The apparatus of claim 13, wherein the resource information locators comprise:
an ID value that is a hash function value obtained by hashing an e-mail address of a node;
an Internet protocol (IP) address indicating an actual address of the node; and
a port number providing a current application service to the node.

15. The apparatus of claim 13, wherein the plurality of nodes periodically transmit an operation acknowledge message to nodes neighboring each of the nodes through the neighboring node table and friend nodes of each of the nodes through the friend node table and measure a round trip time (RTT) to determine whether the neighboring nodes and the friend nodes are operating.

16. The apparatus of claim 15, wherein the plurality of nodes transmit a sharing file list stored by each of the nodes to friend nodes that are operating in the friend nodes, and receive a sharing file list stored by the friend nodes that are operating.
